(19) United States
(12) Patent Application Publication
(10) Pub. No.: US 2020/0184932 A1
(43) Pub. Date: Jun. 11, 2020

(54) METHOD FOR CONTROLLING DISPLAY DEVICE, DISPLAY DEVICE, AND DISPLAY SYSTEM

(71) Applicant: SEIKO EPSON CORPORATION, Tokyo (JP)

(72) Inventors: Toshiki FUJIMORI, Chino-shi (JP); Toru KARASAWA, Kamiina-gun (JP)

(73) Assignee: SEIKO EPSON CORPORATION, Tokyo (JP)

(21) Appl. No.: 16/703,966

(22) Filed: Dec. 5, 2019

(30) Foreign Application Priority Data
Dec. 6, 2018 (JP) 2018-228686

(51) Int. Cl. G09G 5/38; G09G 5/373; G06T 7/70

(52) U.S. Cl. CPC G09G 5/38; G09G 5/373; G06T 2207/30204; G09G 2354/00; G06T 7/70

(57) ABSTRACT

A method for controlling a projector includes: a detection step of detecting a position and a feature of a marker arranged at a screen; a display control step of specifying an image that corresponds to the feature of the marker and deciding a display position of the image, based on the position of the marker; and a display step of displaying the image at the display position.

The present application is based on, and claims priority from JP Application Serial Number 2018-228686, filed Dec. 6, 2018, the disclosure of which is hereby incorporated by reference herein in its entirety.

### BACKGROUND

### 1. Technical Field

The present disclosure relates to a method for controlling a display device, a display device, and a display system.

### 2. Related Art

According to the related art, a display device that can adjust the position where an image is displayed, in response to an operation by a viewer, is known. JP-A-2005-39518 is an example of the related art. A projector described in JP-A-2005-39518 detects a marker radiated from a remote control transmitter. The projector projects a projection image at the position where the detected marker is radiated.

The projector described in JP-A-2005-39518 optimizes a display area in a maximum display area of an image display element according to the position of the detected marker and thus adjusts the projection range of the projector. In this configuration, the position of the image arranged in the projection range of the projector and the content of the image or the like need to be designated separately by an operation on the projector.

### SUMMARY

An aspect of the disclosure is directed to a method for controlling a display device, the method including: a detection step of detecting a position and a feature of a marker arranged at a display surface; a display control step of specifying an image that corresponds to the feature of the marker and deciding a display position of the image, based on the position of the marker; and a display step of displaying the image at the display position.

Another aspect of the disclosure is directed to a display device including: a display unit; and a control unit detecting a position and a feature of a marker arranged at a display surface, specifying an image that corresponds to the feature of the marker, deciding a display position of the image, based on the position of the marker, and causing the image to be displayed at the display position.

In the display device, the control unit may be configured to decide a display size of the image, based on the position of the marker.

In the display device, a relative position between the position of the marker and the display position of the image and a prescribed value of the display size of the image may be set in advance. The control unit may be configured to decide the display position of the image in such a way as to correspond to the relative position set based on the position of the marker, decide the display size of the image to have the prescribed value, and change one or both of the display position and the display size of the image so as to fit within an available display area on the display surface, when the image does not fit within the available display area.

In the display device, the control unit may be configured to reduce the display size of the image to the available display area on the display surface in such a way as to maintain an aspect ratio, when the image does not fit within the available display area.

In the display device, the control unit may be configured to change the relative position between the position of the marker and the display position of the image according to the available display area on the display surface, when the image does not fit within the available display area.

In the display device, the control unit may be configured to decide the display position of the image to become a position such that the position of the marker is above a top-end side of the image or below a bottom-end side of the image.

In the display device, the control unit may be configured to decide the display position of the image, based on positions of a plurality of the markers having a common feature, of the detected markers.

In the display device, the control unit may be configured to decide the display position of the image, based on positions of a plurality of the markers having a common feature and detected at a position satisfying a particular condition.

In the display device, the control unit may be configured to decide the display size of the image, based on a distance between a plurality of the markers.

In the display device, the control unit may be configured to optically detect the marker on the display surface as a detection range.

The display device may include an image pickup unit picking up an image of the display surface. The control unit may be configured to detect the position and the feature of the marker, based on a picked-up image by the image pickup unit.

In the display device, the control unit may be configured to detect a subject having a shape corresponding to a condition, as the marker, from the picked-up image.

In the display device, the control unit may be configured to attempt to detect the marker after starting a display of the image, and stop the display of the image when the marker is not detected within a set time.

In the display device, the control unit may be configured to start the display of the image before detecting the marker.

In the display device, the feature of the marker may be an apparent color or shape of the marker.

Still another aspect of the disclosure is directed to a display system including: a display device; and a marker arranged at a display surface. The display device includes: a display unit; and a control unit detecting a position and a feature of the marker arranged at the display surface, specifying an image that corresponds to the feature of the marker, deciding a display position of the image, based on the position of the marker, and causing the image to be displayed at the display position.

The disclosure can also be implemented in various other forms than the method for controlling the display device, the display device, and the display system described above. For example, the disclosure may be implemented as a program executed by a computer or processor in order to execute the foregoing method. Also, the disclosure can be implemented in the form of a recording medium having the program recorded therein, a server device distributing the program, a transmission medium transmitting the program, a data signal embodying the program within a carrier waver, or the like.

### BRIEF DESCRIPTION OF THE DRAWINGS

FIG. 1 shows the configuration of a projection system.

FIG. 2 shows an operation example of the projection system.

FIG. 3 shows another operation example of the projection system.

FIG. 4 is a block diagram of a projector.

FIG. 5 is a schematic view showing a configuration example of condition data.

FIG. 6 is a transition chart of the operation state of the projection system.

FIG. 7 is a flowchart showing an operation of the projector.

FIG. 8 is a flowchart showing an operation of the projector.

FIG. 9 is a flowchart showing an operation of the projector.

FIG. 10 is a flowchart showing an operation of the projector.

### DESCRIPTION OF EXEMPLARY EMBODIMENTS

### 1. Outline of Projection System

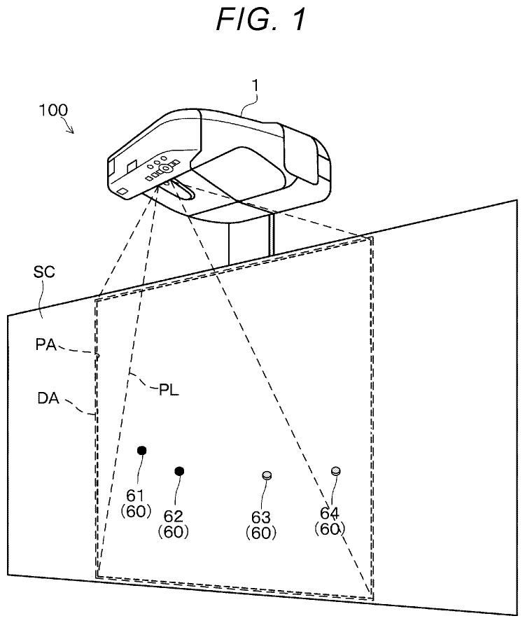

FIG. 1 is a perspective view of a projection system 100 in an embodiment of the disclosure.

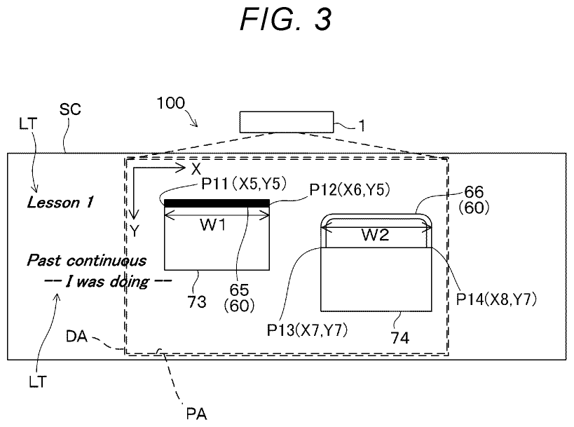

The projection system 100 has a projector 1 and a marker 60. In FIG. 1 and the description below, markers 61, 62, 63, 64 are shown as specific examples of the marker 60. Also, FIG. 3, described later, illustrates markers 65, 66. When not discriminated from each other, these markers 61 to 66 are referred to as the marker 60.

The projector 1 functions as a display device. The projector 1 projects image light PL onto a screen SC as a display surface and thus displays an image on the display surface. The projection system 100 is equivalent to an example of a display system.

The screen SC is, for example, a flat surface such as a wall surface, or a suspended curtain. The screen SC may be anything that can reflect the image light PL emitted from the projector 1 and thus form an image. For example, a blackboard or whiteboard on which a user can write may be used as the screen SC.

The projector 1 projects the image light PL onto the screen SC and thus forms a projection image on the screen SC.

An area where the projector 1 can project the image light PL is defined as a projection area PA. It can be said that the projection area PA is an available display area where the projector 1 can display an image. When the projector 1 is in a normal state of use, the projection area PA is projected to fit within the screen SC. A projection image refers to an area where an image is formed in the projection area PA. The projection image projected by the projector 1 may be a still image or a video. The video is a so-called dynamic image. In the description below, the still image and the video are collectively referred to as the projection image.

In a target range DA set on the screen SC, the projector 1 detects the presence of the marker 60 and specifies the position of the marker 60. Although the target range DA need not coincide with the projection area PA, it is preferable that the target range DA includes the projection area PA. In this embodiment, the case where the target range DA and the projection area PA coincide with each other is described as an example. The projector 1 specifies the position in the projection area PA of the marker 60 detected in the target range DA.

Although FIG. 1 shows an example where four markers 60 are arranged on the screen SC, the number of markers 60 usable in the projection system 100 is not limited. The number of markers 60 may be three or fewer, or may be five or more.

The marker 60 may be anything that can be optically detected on the screen SC and whose position on the screen SC can be optically specified. The marker 60 may be an object or a pattern or state formed on the screen SC.

Specifically, the marker 60 may be an object that is independent of the screen SC. The marker 60 may also be a pattern, letter, geometric shape or the like drawn within the target range DA on the screen SC. The marker 60 may also be a pattern, letter, geometric shape or the like formed by pasting or other measures in the target range DA.

As an example, the markers 61, 62, 63, 64 shown in FIG. 1 are disk-shaped objects. The user can manually move the markers 61, 62, 63, 64 and fix the markers 61, 62, 63, 64 at an arbitrary position on the screen SC. For example, the markers 61, 62, 63, 64 have an adhesive material and are fixed to the screen SC by an adhesive force. Also, for example, the screen SC may be formed using a material that can attract a magnet. In this case, the markers 61, 62, 63, 64 may have a configuration including a permanent magnet so as to be able to be fixed at an arbitrary position on the screen SC.

The markers 61, 62, 63, 64 may also be attracted to the screen SC by an electrostatic force. Other than these, the method of fixing the markers 61, 62, 63, 64 to the screen SC can be arbitrarily changed.

The projector 1 can detect a feature of the marker 60. The feature of the marker 60 refers to an optically identifiable attribute such as apparent color, pattern or shape. The optically identifiable attribute is not limited to an attribute that can be detected and identified using visible light, but also includes an attribute that can be detected and identified using infrared light or ultraviolet light. For example, the marker 61 and the marker 62 are in the same color. The marker 61 and the marker 63 are in different colors from each other. The marker 63 and the marker 64 are in the same color. In this example, the markers 61, 62 have the same feature, and the markers 63, 64 have the same feature.

### 2. Operation Example of Projection System

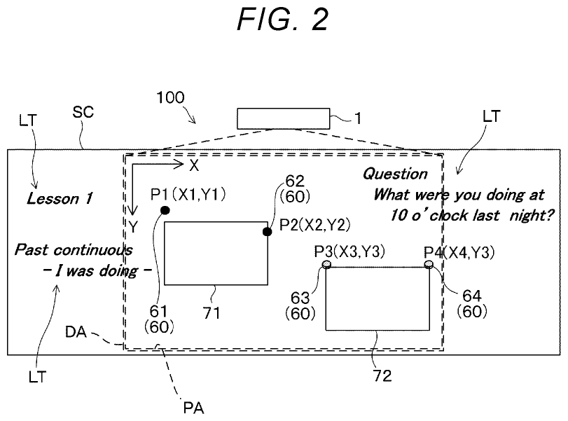

FIGS. 2 and 3 show an operation example of the projection system 100.

The example in FIG. 2 shows an operation in which the projector 1 projects projection images 71, 72 corresponding to the position of the marker 60.

The projector 1 detects the marker 60 in the target range DA. In the example in FIG. 2, the projector 1 detects each of the markers 61, 62, 63, 64 and specifies the position of each marker 61, 62, 63, 64. The projector 1 specifies the markers 61, 62, 63, 64, based on each feature. For example, the marker 61 and the marker 62 have a common feature, and the marker 63 and the marker 64 have a common feature.

The projector 1 decides the position of the projection image in the projection area PA and the size of the projection image, based on the positions of the detected markers 61, 62, 63, 64. The projector 1 decides the position of the projection image, based on the positions of the markers 60 having a common feature. For example, the projector 1 decides the position of the projection image 71, based on the positions of the markers 61, 62, and decides the position of the projection image 72, based on the positions of the markers 63, 64.

When the projector 1 has detected the marker 60 in the target range DA, the projector 1 specifies the coordinates of the marker 60 in the projection area PA.

In this embodiment, an X-Y orthogonal coordinate system on a two-dimensional plane parallel to the screen SC is set in the projection area PA. An X-axis direction is along the horizontal direction of the screen SC. A Y-axis direction is along the vertical direction of the screen SC. The projector 1 specifies the X-coordinate and Y-coordinate in the projection area PA, of the position of the marker 60. For example, the coordinates of a position P1 of the marker 61 are (X1, Y1). The coordinates of a position P2 of the marker 62 are (X2, Y2). The coordinates of a position P3 of the marker 63 are (X3, Y3). The coordinates of a position P4 of the marker 64 are (X4, Y3).

The marker 61 is disk-shaped and has a predetermined size. The projector 1 specifies, for example, the center or centroid of the marker 61 and defines this as the position P1. This is simply an example. The projector 1 may define the top end of the marker 61 as the position P1 or define the bottom end as the position P1. The same applies to the markers 62, 63, 64.

As the processing to find the coordinates of the marker 60, the projector 1 performs, for example, the processing of detecting the position of the marker 60 in the target range DA and converting the detected position into coordinates in the projection area PA.

To decide the position of the projection image based on the position of the marker 60, various methods can be employed.

The projector 1 uses the position of the marker 60 as a reference and decides the position of the projection image in such a way that the position of the projection image is a preset relative position to the reference. As an example, when the relative position of the projection image to the reference is set in the Y-axis direction, the projector 1 arranges the position of the projection image below the marker 60, with the marker 60 located at the top end of the projection image. The projector 1 also decides the size of the projection image in such a way that the position of the marker 60 is at an end of the projection image. In FIG. 2, the position and the size of the projection image 72 are decided, with the position P3 located at the top left end of the projection image 72, and the position P4 located at the top right end of the projection image 72.

The relative position of the projection image to the position of the marker 60 is not limited to below the position of the marker 60 and may be set above, to the right of, or to the left of the marker 60, or the like. The size of the projection image is not limited to a size decided by locating the position of the marker 60 at an end of the projection image but may be a preset size.

The method of finding a reference from the position of the marker 60 is not limited to defining the marker 60 as a reference but may be arithmetically processing the positions of a plurality of markers 60 to decide a reference. For example, the projection image 71 is arranged in the Y-axis direction, based on the average value of the Y-coordinates of the position P1 and the position P2 as a reference. That is, the Y-coordinate of the top end of the projection image 71 is the average value of the Y-coordinates of the position P1 and the position P2.

Also, for example, the projector 1 may decide the position of the projection image based on the position of one marker 60. For example, the projector 1 may decide the position of the projection image in such a way that the position of the marker 60 is at a designated end, of the top, bottom, left, and right ends. Also, the size of the projection image may be, for example, a prescribed size.

In FIG. 2, the position of the projection image 71 is decided, based on the positions of the two markers 61, 62. However, the number of markers 60 used to decide the position of the projection image is not limited. For example, the projector 1 may decide the position of the projection image, based on the position of one marker 60. The projector 1 may also decide the position of the projection image, based on the positions of three or more markers 60.

The projector 1 projects the projection image 71 and the projection image 72 with the decided position and size. The projector 1 has data of images projected in the projection area PA. The images held by the projector 1 correspond to features of the markers 60. When the projector 1 has detected the marker 60, the projector 1 selects and projects an image corresponding to the feature of the marker 60. For example, the projection image 71 is an image corresponding to the features of the markers 61, 62. The projection image 72 is an image corresponding to the features of the markers 63, 64.

Thus, as the user places the marker 60 on the screen SC, the projection image corresponding to the feature of the marker 60 is projected at the position corresponding to the position of the marker 60.

FIG. 2 shows an example where the screen SC is formed of a surface on which the user can write, such as a whiteboard or blackboard. On the screen SC, a letter LT is arranged by handwriting or the like. The screen SC may also be a display screen of a flat-panel display device such as a liquid crystal display or plasma display. In this case, the letter LT is equivalent to a letter or image displayed by the display device forming the screen SC.

When the user wants the projection image 71 to be projected in such a way as to avoid the letter LT or correspond to the letter LT, the user places the markers 61, 62 having a feature corresponding to the projection image 71, on the screen SC.

The projector 1 projects the projection image 71 in such a way as to correspond to the positions of the markers 61, 62. The user can have a desired image projected at a desired position, by a simple operation of arranging the marker 60 on the screen SC. Therefore, an operation of designating a projection position and an operation of selecting an image by the user can be omitted. This improves convenience.

Also, as described above, the markers 61, 62, 63, 64 may be not separate objects from the screen SC and may be images drawn on the screen SC. Therefore, the user can arrange the projection images 71, 72 at a desired position by handwriting the marker 60 on the screen SC or by pasting a sticker to serve as the marker 60 to the screen SC. Also, the display device forming the screen SC may display the marker 60.

FIG. 3 shows an operation example where the projector 1 projects projection images 73, 74 corresponding to the position of the marker 60. The shape of the marker 60 is different from the example in FIG. 2.

The marker 65 illustrated in FIG. 3 is a bar. The marker 66 is U-shaped. The markers 65, 66 may be formed of an arbitrary material and may be formed of a synthetic resin or a metal. For example, a metal pipe bent into U-shape can be used as the marker 66. In this way, the marker 60 may be various tools or components used for other purposes than the use for the projector 1.

When the projector 1 has detected the marker 60 having a size equal to or greater than a set value in the X-axis direction or the Y-axis direction, the projector 1 specifies the position of an end of the marker 60 and decides the position of the projection image, based on the specified position of the end as a reference. In the example in FIG. 3, the projector 1 specifies the coordinates (X5, Y5) of a position P11 and the coordinates (X6, Y5) of a position P12 of the ends of the marker 65 in the projection area PA. The projector 1 decides the position of the projection image 73, based on the positions P11, P12 as a reference. The relative position of the projection image 73 to the positions P11, P12 and the size of the projection image 73 are based on a presetting.

For example, when the difference in Y-coordinate between the position P11 and the position P12 is within a predetermined range, the position of the projection image 73 is decided in such a way that a straight line connecting the position P11 and the position P12 is located at the top end of the projection image 73. As the size of the projection image 73, a prescribed value may be employed. The size of the projection image 73 may also be decided according to a distance W1 between the position P11 and the position P12. In this case, the projection image 73 is enlarged or reduced according to the distance W1 in such a way as to maintain the aspect ratio of the projection image 73.

As for the marker 60 having a predetermined size or greater in the X-axis direction and the Y-axis direction, such as the marker 66, for example, the bottom end of the marker 66 can be set as a reference for the projection position of the projection image 74. In this case, the projection image 74 is arranged below the marker 66, as shown in FIG. 3. The size of the projection image 74 can be a size according to a distance W2 in the X-axis direction of the marker 66.

### 3. Configuration of Projector

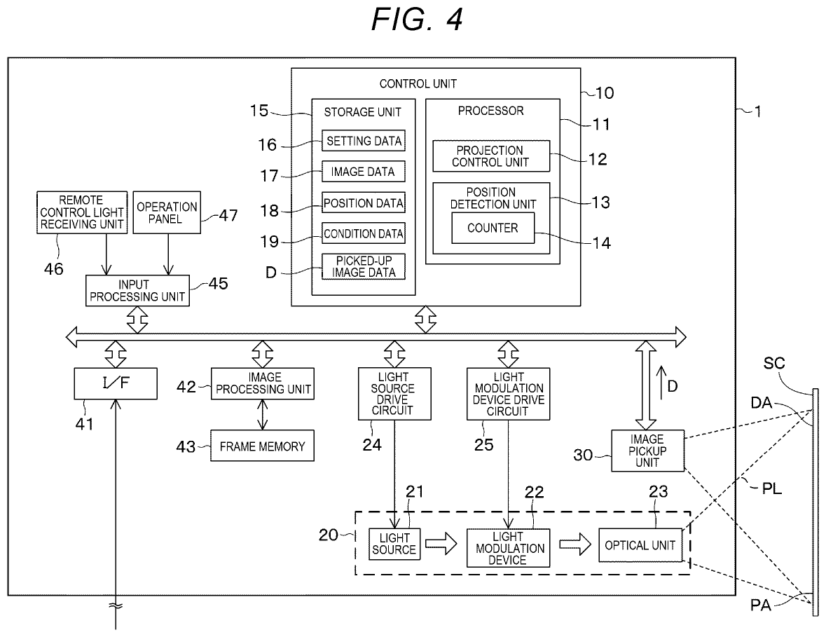

FIG. 4 is a block diagram of the projector 1.

The projector 1 has a control unit 10 controlling each part of the projector 1. The control unit 10, for example, may have an arithmetic processing device executing a program and implement the function of the control unit 10 by a collaboration between hardware and software. Alternatively, the control unit 10 may be formed of hardware programmed to perform an arithmetic processing function. In this embodiment, a configuration that has a storage unit 15 storing a program and a processor 11 executing the program is provided as an example of the control unit 10. The processor 11 is an arithmetic processing device formed of a CPU (central processing unit) or microcomputer or the like. The processor 11 executes a control program stored in the storage unit 15 and thus controls each part of the projector 1.

The storage unit 15 has a non-volatile storage area storing, in a non-volatile manner, a program executed by the processor 11 and data processed by the processor 11. The storage unit 15 may have a volatile storage area and thus form a work area temporarily storing a program executed by the processor 11 and processing target data.

For example, in this embodiment, the storage unit 15 stores setting data 16, image data 17, position data 18, condition data 19, and picked-up image data D.

The setting data 16 includes a set value about a processing condition of various kinds of processing executed by the processor 11. The setting data 16 may also include a set value about image processing executed by an image processing unit 42.

The setting data 16 may also include information about the size of the projection image of the projector 1. That is, the setting data 16 may include information designating a prescribed value or an initial value of the size of the projection image projected by the projector 1 based on the marker 60. The setting data 16 may also include information about the aspect ratio of the projection image.

The image data 17 is image data inputted from an interface 41, described later. A projection control unit 12 causes a projection unit 20 to project an image based on the image data 17. The storage unit 15 can store a plurality of the image data 17. The projector 1 selects and projects one of the image data 17 stored in the storage unit 15. At least a part of the image data 17 stored in the storage unit 15 is stored in the storage unit 15, corresponding to a feature of the marker 60.

The image data 17 may include information about the size when the image is projected by the projector 1, or such information may be added to the image data 17. That is, the image data 17 may include a prescribed value of the size and aspect ratio of the projection image when the projection image is projected by the projector 1.

The position data 18 is data for calculating coordinates in the projection area PA. Specifically, the position data 18 is data establishing a correspondence between a position in the picked-up image data D and a position in the projection area PA. The position data 18 is generated, for example, by calibration executed after the projector 1 is installed.

The condition data 19 is data prescribing processing about the marker 60 and is referred to in the processing to decide the position and the size of the projection image based on the position of the marker 60.

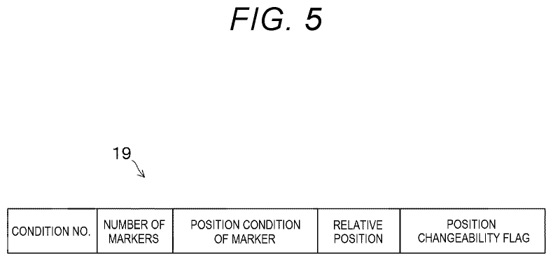

FIG. 5 is a schematic view showing a configuration example of the condition data 19.

The storage unit 15 can be configured to store a plurality of the condition data 19.

The condition data 19 includes identification information that can identify this condition data 19 from the other condition data 19 stored in the storage unit 15. The condition data 19 illustrated in FIG. 5 includes a condition number as the identification information. However, this is simply an example. The identification information is not limited to a number.

In the example in FIG. 5, the condition data 19 includes the number of markers 60, a position condition of the marker 60, a relative position, and a position changeability flag, in addition to the condition number. The position condition is information designating a condition for applying the condition data 19. Specifically, when the position of the marker 60 detected in the target range DA satisfies the position condition of the condition data 19, the setting of the condition data 19 is applied.

The relative position included in the condition data 19 is information designating the relative position of the projection image to the position of the marker 60. For example, in the example in FIG. 2, the projection image 72 is located below the positions P3, P4. The projection image 72 in FIG. 2 is an example where the position information of the condition data 19 is set in such a way that the relative position of the projection image comes below the marker 60.

The position changeability flag is information representing whether it is allowable or not to change the position of the projection image designated by the relative position of the condition data 19. When the position changeability flag is ON, position change is allowed. For example, when deciding the position of the projection image according to the relative position of the condition data 19 causes a part or all of the projection image to come out of the projection area PA, the projector 1 changes the position or size of the projection image. The projector 1 changes the position of the projection image when the position changeability flag is ON. The projector 1 changes the size of the projection image when the position changeability flag is OFF.

The picked-up image data D is data of a picked-up image picked up by an image pickup unit 30.

The processor 11 may be formed of a single processor or a plurality of processors. The processor 11 may be formed of an SoC (system on chip) integrated with a part or the whole of the storage unit 15 and/or another circuit. Also, as described above, the processor 11 may be formed of a combination of a CPU executing a program and a DSP (digital signal processor) executing predetermined arithmetic processing. All the functions of the processor 11 may be configured as installed in hardware or may be configured using a programmable device. The processor 11 may also serve as the image processing unit 42. That is, the processor 11 may execute the function of the image processing unit 42.

The processor 11 has the projection control unit 12 performing control to project the image light PL. The projection control unit 12 controls the image processing unit 42, a light source drive circuit 24, and a light modulation device drive circuit 25 and thus causes the projection unit 20 to project an image based on the image data 17.

The processor 11 has a position detection unit 13 detecting the marker 60. The position detection unit 13 detects the marker 60 on the screen SC and specifies the coordinates of the marker 60 in the projection area PA.

Specifically, the position detection unit 13 causes the image pickup unit 30 to execute image pickup and thus acquires the picked-up image data D. The position detection unit 13 analyzes the picked-up image data D and detects the marker 60 having a preset feature. The feature of the marker 60 is designated by an optically identifiable attribute such as apparent color, pattern or shape. The position detection unit 13 acquires the feature of the marker 60 corresponding to the image data 17 stored in the storage unit 15 and detects the marker 60 corresponding to the acquired feature, in the picked-up image data D.

The position detection unit 13 specifies the position in the picked-up image data D, of the marker 60 detected from the picked-up image data D. That is, the position detection unit 13 specifies the position of the marker 60 detected in the picked-up image data D and converts the position of the marker 60 in the picked-up image data D into coordinates in the projection area PA, using the position data 18.

The position detection unit 13 acquires the condition data 19 corresponding to the coordinates of the marker 60. In other words, the position detection unit 13 determines which of the condition data 19 stored in the storage unit 15 is the condition data 19 having the position condition to which the position of the marker 60 detected from the picked-up image data D corresponds. The position detection unit 13 acquires the relative position and the position changeability flag of the corresponding condition data 19.

The position detection unit 13 decides the position and the size of the projection image, based on the relative position and the position changeability flag of the condition data 19 and the coordinates of the marker 60.

The projection control unit 12 projects an image based on the image data 17 corresponding to the feature of the marker 60 detected by the position detection unit 13, according to the position and the size decided by the position detection unit 13.

The position detection unit 13 has a counter 14. The counter 14 counts the number of times the processing to detect the marker 60 from the picked-up image data D is attempted. The position detection unit 13 periodically executes the processing to detect the marker 60 from the picked-up image data D, every preset time. When the position detection unit 13 executes the detection of the marker 60 a plurality of times, the counter 14 counts the number of times the marker 60 is detected consecutively. This number of times is referred to as the number of consecutive detections.

When the position detection unit 13 executes the detection of the marker 60 a plurality of times, the counter 14 also counts the number of times the marker 60 is undetected consecutively. This number of times is referred to as the number of consecutive absences. The position detection unit 13 controls start of counting by the counter 14, stop of counting, and resetting of the count value.

In the projector 1, a part of the projection control unit 12 and the position detection unit 13 can be formed of separate hardware from the processor 11.

The projector 1 has the projection unit 20. The projection unit 20 has a light source 21, a light modulation device 22, and an optical unit 23. The light source drive circuit 24 and the light modulation device drive circuit 25 operating under the control of the control unit 10 are coupled to the projection unit 20. The projection unit 20 is equivalent to an example of a display unit.

The light source 21 is formed of a solid-state light source such as an LED or laser light source. The light source 21 may also be a lamp such as a halogen lamp, xenon lamp, or ultra-high-pressure mercury lamp. The light source 21 is driven to emit light by the light source drive circuit 24. The projector 1 may have a drive circuit supplying electric power to the light source 21 under the control of the control unit 10.

The light modulation device 22 modulates the light emitted from the light source 21, thus generates the image light PL, and casts the image light PL onto the optical unit 23. The light modulation device 22 has, for example, a light modulation element such as a transmission-type liquid crystal light valve, reflection-type liquid crystal light valve, or digital mirror device. The light modulation element of the light modulation device 22 is coupled to the light modulation device drive circuit 25. The light modulation device drive circuit 25 drives the light modulation element of the light modulation device 22, and thus causes the light modulation of the light modulation device 22 to form an image, line by line, and ultimately form an image of each frame. The light modulation device 22 may have a drive circuit driving the light modulation element. For example, when the light modulation device 22 is formed of a liquid crystal light valve, the light modulation device 22 may have a liquid crystal driver circuit as the drive circuit.

The optical unit 23 has an optical element such as a lens and mirror. The optical unit 23 causes the image light PL to form an image on the screen SC and thus displays a projection image based on the image data 17 onto the screen SC.

As shown in FIG. 4, the projector 1 may have the interface 41, the image processing unit 42, and an input processing unit 45. These components are coupled to the control unit 10.

The interface 41 is an interface to which image data is inputted. Although not illustrated, the interface 41 has a connector to which a transmission cable is coupled, and an interface circuit receiving image data via the transmission cable.

An image supply device supplying image data can be coupled to the interface 41. As the image supply device, for example, a laptop PC (personal computer), desktop PC, tablet terminal, smartphone, or PDA (personal digital assistant) can be used. The image supply device may be a video player, DVD (digital versatile disk) player, Blu-ray disc player or the like. The image supply device may also be a hard disk recorder, television tuner device, CATV (cable television) set-top box, video game machine or the like. The image data inputted to the interface 41 may be dynamic image data or still image data and has an arbitrary data format.

The image processing unit 42 processes the image data inputted to the interface 41. A frame memory 43 is coupled to the image processing unit 42. The image processing unit 42 processes the image data of the image projected by the projection unit 20, under the control of the projection control unit 12. The image processing unit 42 may be configured to process every several lines to every several tens of lines of only a part of the area of the frame memory 43 and not to use the frame memory 43 as a frame memory for the whole screen.

The image processing unit 42 executes various kinds of processing including, for example, geometric correction processing to correct a keystone distortion of the projection image, and OSD processing to superimpose an OSD (on-screen display) image. The image processing unit 42 may perform image adjustment processing to adjust the luminance and color tone of the image data. The image processing unit 42 may perform resolution conversion processing to adjust the aspect ratio and resolution of the image data according to the light modulation device 22. The image processing unit 42 may execute other image processing such as frame rate conversion.

The image processing unit 42 generates an image signal based on the processed image data and outputs the image signal to the light modulation device 22. Based on the image signal outputted from the image processing unit 42, the projection control unit 12 causes the light modulation device 22 to operate, and causes the projection unit 20 to project the image light PL.

The input processing unit 45 accepts an input to the projector 1. The input processing unit 45 is coupled to a remote control light receiving unit 46 receiving an infrared signal transmitted from a remote controller, not illustrated, and an operation panel 47 provided at the main body of the projector 1. The input processing unit 45 decodes the signal received by the remote control light receiving unit 46 and detects an operation by the remote controller. The input processing unit 45 also detects an operation on the operation panel 47. The input processing unit 45 outputs data representing the content of the operation to the control unit 10.

The projector 1 has the image pickup unit 30 as a component for detecting the marker 60 and specifying its position. The image pickup unit 30 is a so-called digital camera. The image pickup unit 30 executes image pickup under the control of the position detection unit 13 and outputs the picked-up image data D to the control unit 10. The image pickup range of the image pickup unit 30, that is, the angle of view, includes the target range DA set on the screen SC.

The image pickup unit 30 has a CMOS (complementary metal-oxide semiconductor) image sensor or CCD (charge-coupled device) image sensor. The image pickup unit 30 has a data processing circuit generating the picked-up image data D from the light receiving state of the image sensor. The image pickup unit 30 may be configured to perform image pickup via visible light or may be configured to perform image pickup via light with a wavelength outside the visible range such as infrared light or ultraviolet light.

The picked-up image data D is not limited to any specific format. For example, the picked-up image data D may be raw data or image data in the JPEG (Joint Photographic Experts Group) format. Alternatively, the picked-up image data D may be image data in the PNG (Portable Network Graphics) format or other formats.

### 4. Transition of Operation State of Projection System

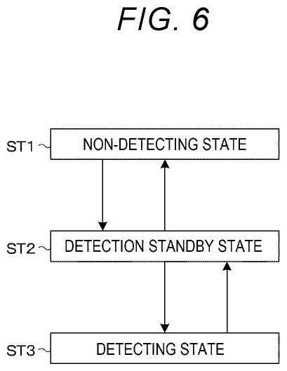

FIG. 6 is a transition chart of the operation state of the projection system 100.

The projection system 100 operates in three operation states, that is, a non-detecting state ST1, a detection standby state ST2, and a detecting state ST3. The non-detecting state ST1 is the state where the marker 60 is not detected in the target range DA. The detection standby state ST2 is the state where the projection system 100 waits for the marker 60 to be arranged in the target range DA. In the detection standby state ST2, the projector 1 can detect the marker 60. The detecting state ST3 is the state where a projection image is projected in response to the detection of the marker 60.

The projector 1 shifts into the non-detecting state ST1 after startup. In the non-detecting state ST1, the projector 1 does not project a projection image onto the screen SC.

When the projector 1 is ready to detect the marker 60 in the non-detecting state ST1, the projector 1 shifts into the detection standby state ST2. In the detection standby state ST2, the projector 1 performs processing to pick up an image of the target range DA by the image pickup unit 30 and detect the marker 60. In the detection standby state ST2, when the marker 60 is detected, the projector 1 shifts into the detecting state ST3.

In the detecting state ST3, the projector 1 projects a projection image based on the position of the marker 60. On starting the projection of the projection image, the projector 1 shifts into the detection standby state ST2. In the state of projecting the projection image, the projector 1 can perform the operation of the detection standby state ST2. In the detection standby state ST2, when the marker 60 as a reference for the position of the projection image is no longer detected, the projector 1 shifts into the non-detecting state ST1. The non-detecting state ST1 is the state where the marker 60 is not detected. Therefore, the projector 1 stops projecting the image at the time of this shift. Subsequently, the projector 1 shifts from the non-detecting state ST1 into the detection standby state ST2.

In the detection standby state ST2, the projector 1 shifts into the detecting state ST3 when the marker 60 is detected, regardless of whether the projector 1 is projecting an image or not. That is, when the projector 1 in the state of not projecting an image shifts from the detection standby state ST2 into the detecting state ST3, the projector 1 then projects a projection image. When the projector 1 in the state of projecting an image shifts from the detection standby state ST2 into the detecting state ST3, the projector 1 projects a projection image, based on the position of a newly detected marker 60. Thus, the projector 1 can project a plurality of projection images respectively based on the positions of a plurality of markers 60.

### 5. Operation of Projection System

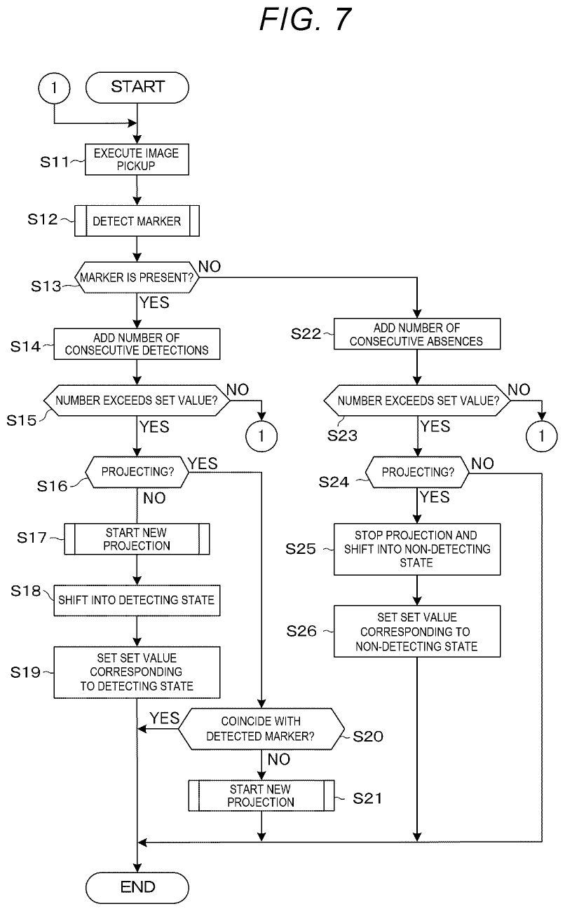

FIGS. 7, 8, 9, and 10 are flowcharts showing operations of the projector 1. The operation in FIG. 7 is executed in the detection standby state ST2.

The position detection unit 13 controls the image pickup unit 30 to execute image pickup (step S11). The image pickup unit 30 executes image pickup under the control of the position detection unit 13 and outputs the picked-up image data D to the control unit 10. The picked-up image data D is stored into the storage unit 15.

The position detection unit 13 detects the marker from the picked-up image data D by marker detection processing (step S12).

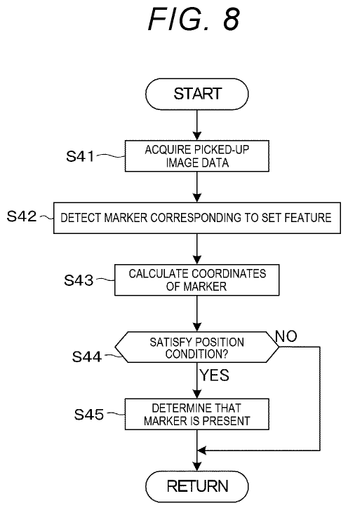

FIG. 8 is a flowchart showing details of the marker detection processing.

The position detection unit 13 acquires the picked-up image data D (step S41), then searches the picked-up image data D for a marker 60 corresponding to a feature set corresponding to the image data 17, and detects the marker 60 (step S42).

The position detection unit 13 calculates the coordinates of the marker 60 in the projection area PA from the position of the marker 60 detected in the target range DA, using the position data 18 (step S43).

The position detection unit 13 determines whether the coordinates of the marker 60 satisfy the position condition of the condition data 19 or not (step S44). In other words, the position detection unit 13 in step S44 determines whether or not there is the condition data 19 having the position condition to which the coordinates of the marker 60 correspond.

When it is determined that the coordinates of the marker 60 satisfy the position condition (YES in step S44), the position detection unit 13 determines that the marker 60 is detected in the target range DA (step S45) and returns to the operation in FIG. 7. Meanwhile, when it is determined that the coordinates of the marker 60 do not satisfy the position condition (NO in step S44), the position detection unit 13 returns to the operation in FIG. 7.

When the marker 60 is not detected in the picked-up image data D, the position detection unit 13 may end the processing at step S42 and return to the operation of FIG. 7.

The processing to search the picked-up image data D for the marker 60 in step S42 can be performed, for example, using a known image processing library.

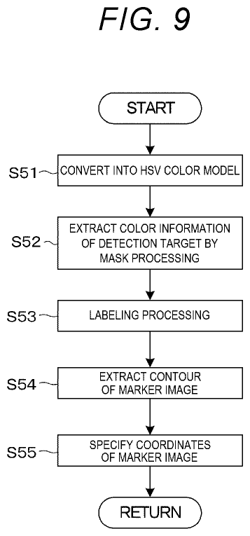

FIG. 9 is a flowchart showing processing to detect the marker 60 having a color feature, as a specific example of the processing to search for the marker 60 in step S42.

The position detection unit 13 performs processing to convert the picked-up image data D into the HSV color model (step S51) and performs mask processing of the converted picked-up image data D (step S52).

In step S52, mask processing to extract, from the picked-up image data D, color information corresponding to the feature color of the marker 60 to be detected, is performed. That is, in step S52, the color of the marker 60 of the detection target has already been decided. This color is the feature of the marker 60 corresponding to the image data 17 stored in the storage unit 15.

The color information extracted in step S52 corresponds to the position where the color of the marker 60 of the detection target is taken out from the picked-up image data D. Therefore, the extracted color information can be regarded as an image of the marker 60 present in the target range DA. The position detection unit 13 labels the color information extracted in step S52 (step S53). The position detection unit 13 specifies the part labeled in step S53 as an image of the marker 60 in the picked-up image data D and extracts a contour of the image (step S54). The position detection unit 13 specifies the position of the marker 60 and calculates its coordinates, based on the contour of the image of the marker 60 (step S55). For example, the position detection unit 13 finds the centroid of the extracted contour, specifies the position of the centroid as the position of the marker 60, and calculates its coordinates in the projection area PA.

Back to FIG. 7, the position detection unit 13 determines whether the marker 60 is detected by the marker detection processing or not (step S13). When the marker 60 is detected (YES in step S13), the position detection unit 13 adds the number of consecutive detections counted by the counter 14 (step S14). The number of consecutive detections is counted at each position of the marker 60. For example, when the marker 60 is detected at a plurality of positions in the target range DA, the counter 14 counts the number of consecutive detections at each of the detected positions. Therefore, when a plurality of markers 60 are detected in the target range DA, the number of consecutive detections is counted individually for each marker 60.

The position detection unit 13 determines whether the count value of the number of consecutive detections by the counter 14 exceeds a set value or not (step S15). When the counter 14 counts the number of consecutive detections with respect to a plurality of markers 60, the position detection unit 13 in step S15 determines whether or not there is a marker 60 whose number of consecutive detections exceeds the set value.

When the count value of the number of consecutive detections does not exceed the set value (NO in step S15), the position detection unit 13 returns to step S11.

When the count value of the number of consecutive detections exceeds the set value (YES in step S15), the position detection unit 13 determines whether the projection unit 20 is projecting a projection image or not (step S16).

When a projection image is not being projected (NO in step S16), that is, when a shift from the non-detecting state ST1 into the detection standby state ST2 is made, the control unit 10 executes new projection start processing and starts projecting an image (step S17). Subsequently, the control unit shifts into the detecting state ST3 (step S18).

The position detection unit 13 sets a set value corresponding to the detecting state ST3 (step S19) and ends this processing. As described above, the control unit 10 repeatedly executes the operation in FIG. 7 in a set cycle.

The set value set in step S19 is a set value that serves as a reference for determining the number of consecutive detections in step S15 and a set value that serves as a reference for determining the number of consecutive absences in step S23, described later. The set values for the number of consecutive detections and the number of consecutive absences are set to be values corresponding to the non-detecting state ST1 and the detecting state ST3. These set values are included, for example, in the setting data 16.

When a projection image is being projected (YES in step S16), the position detection unit 13 determines whether the projection image coincides with the marker 60 already detected in the operation in the past in FIG. 7 or not (step S20). That is, the position detection unit 13 determines whether a projection image corresponding to the marker 60 detected in step S12 is already projected or not.

When the projection image coincides with the already detected marker 60 (YES in step S20), the position detection unit 13 ends this processing.

When the projection image does not coincide with the already detected marker 60 (NO in step S20), the control unit 10 executes new projection start processing and newly projects a projection image based on the marker 60 detected in step S12 (step S21). The control unit 10 then ends this processing.

Meanwhile, when it is determined that the marker 60 is not detected in the target range DA (NO in step S13), the position detection unit 13 adds the count value of the number of consecutive absences counted by the counter 14 (step S22).

The position detection unit 13 determines whether the count value of the number of consecutive absences by the counter 14 exceeds a set value or not (step S23).

When the count value of the number of consecutive absences does not exceed the set value (NO in step S23), the position detection unit 13 returns to step S11.

When the count value of the number of consecutive absences exceeds the set value (YES in step S23), the position detection unit 13 determines whether the projection unit 20 is projecting a projection image or not (step S24).

When a projection image is not being projected (NO in step S24), that is, when a shift from the non-detecting state ST1 into the detection standby state ST2 is made, the control unit 10 ends this processing.

When a projection image is being projected (YES in step S24), the position detection unit 13 stops projecting the image and shifts into the non-detecting state ST1 (step S25). The position detection unit 13 sets a set value corresponding to the non-detecting state ST1 (step S26) and ends this processing.

According to the operation in FIG. 7, when a marker 60 is detected in the target range DA and the position of the detected marker 60 satisfies the position condition of the condition data 19, the projection of a projection image corresponding to the position of the marker 60 is started. When a new marker 60 is detected in the state where an image is projected, the projection of a projection image corresponding to the newly detected marker 60 is started.

The position detection unit 13 starts projecting the projection image when the number of consecutive detections exceeds a set value. Therefore, the projection of the projection image is not started until the period during which the marker 60 is present in the target range DA reaches a period corresponding to the set value. That is, when there is a marker detected in the target range DA beyond the period corresponding to the set value, an image corresponding to this marker 60 is projected. Therefore, the processing to project an image is not performed when the marker 60 is detected in the target range DA by accident or when the presence of the marker 60 is temporary. Thus, complication of the operation of the projector 1 can be avoided. Also, since the projection of an image is not performed frequently, the operability of the projector 1 can be improved.

When no marker 60 is detected in the target range DA in the state where an image is projected, the projection of the image is stopped. Therefore, the projection image can be erased in response to the elimination of the marker 60 from the target range DA. The number of consecutive absences is set in the processing to stop the projection, and the projection is stopped when the number of consecutive absences exceeds a set value. Therefore, the situation where the projection is stopped when the marker 60 is temporarily not detected can be prevented. Thus, complication of the operation of the projector 1 can be avoided and the operability of the projector 1 can be improved.

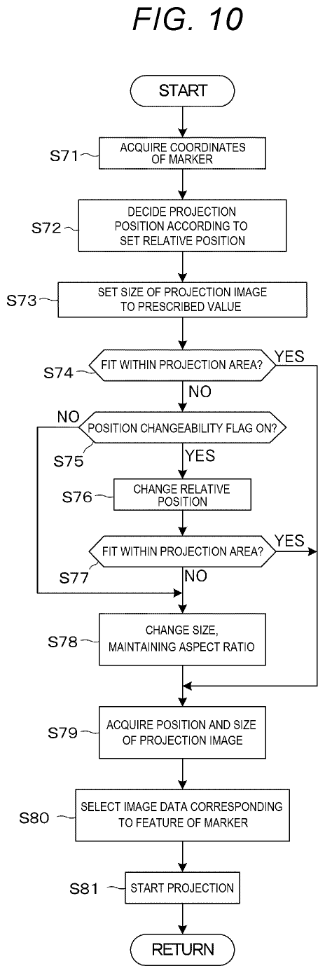

FIG. 10 is a flowchart showing details of the new projection start processing executed in steps S17 and S21. The operation in FIG. 10 is executed by the projection control unit 12 and the position detection unit 13.

The position detection unit 13 acquires the coordinates of the marker 60 detected in the marker detection processing of step S12 (step S71). The position detection unit 13 acquires information about a set relative position from the condition data 19 having a condition which the acquired coordinates satisfy, and decides the position of the projection image according to the acquired information (step S72). The position detection unit 13 sets the size of the projection image to a prescribed value (step S73).

The position detection unit 13 determines whether the projection image arranged at the position decided in step S72 and in the size set in step S73 fits within the projection area PA or not (step S74). When it is determined that the projection image fits within the projection area PA (YES in step S74), the control unit 10 shifts to step S79, described later.

When it is determined that the projection image does not fit within the projection area PA (NO in step S74), the position detection unit 13 determines whether the position changeability flag of the condition data 19 is ON or not (step S75). When the position changeability flag is ON (YES in step S75), the position detection unit 13 changes the relative position of the projection image to the coordinates of the marker 60 (step S76). The position detection unit 13 determines again whether the projection image fits within the projection area PA or not (step S77). When it is determined that the projection image fits within the projection area PA (YES in step S77), the control unit 10 shifts to step S79, described later.

When the position changeability flag is not ON (NO in step S75), and when it is determined that the projection image does not fit within the projection area PA (NO in step S77), the position detection unit 13 changes the projection size (step S78). In step S78, the position detection unit 13 performs processing to reduce the size of the projection image, maintaining the aspect ratio of the projection image, and defines the reduced size as the size of the projection image. Subsequently, the position detection unit 13 shifts to step S79.

In step S79, the projection control unit 12 acquires the position and the size of the projection image decided by the position detection unit 13 (step S79). The projection control unit 12 selects the image data 17 corresponding to the feature of the marker 60 detected in step S12 (step S80) and projects the selected image data 17 according to the position and the size acquired in step S79 (step S81).

As described above, the projection system 100 in this embodiment has the projector 1 and the marker 60. The projector 1 is a display device displaying an image on the screen SC and has the projection unit 20. The projector 1 has the control unit 10 detecting the position and the feature of the marker 60 arranged on the screen SC, specifying an image corresponding to the feature of the marker 60, deciding a display position of the image based on the position of the marker 60, and causing the projection unit 20 to display the image at this display position.

A method for controlling the projector 1 includes a detection step, a display control step, and a display step executed by the control unit 10. In the detection step, the position detection unit 13 detects the position and the feature of the marker 60 arranged at the screen SC. In the display control step, the position detection unit 13 specifies an image corresponding to the feature of the marker 60 and decides the display position of the image, based on the position of the marker 60. In the display step, the projection unit 20 displays the image at the specified display position.

In the method for controlling the display device according to the disclosure and the projector 1 to which the display device is applied, based on the position of the marker arranged in the target range DA, a projection image corresponding to the feature of the marker 60 is projected. Therefore, the user can display a desired image at a desired display position.

For example, the user may carry out an operation to arrange the marker 60 having a feature corresponding to an image to be displayed, at the position where the image is to be displayed in the target range DA. Thus, the user can display a desired image at a desired display position by a simpler operation than when carrying out an operation to designate an image or an operation to designate a display position of an image via a remote controller or an operation panel.

The projection system 100 to which the display system according to the disclosure is applied has the projector 1 and the marker 60 and therefore has the foregoing effects.

In the projector 1, the control unit 10 decides a display position of an image and a display size of the image, based on the position of the marker 60. In the display control step, the projector 1 decides the display position of the image and the display size of the image, based on the position of the marker 60.

Since the size of the projection image is thus decided based on the position of the marker 60, the user can adjust the arrangement of the marker 60 so as to project the image in a desired size.

In the projector 1, a relative position between the position of the marker 60 and the display position of the image, and a prescribed value of the display size of the image, are set in advance. The control unit 10 decides the display position of the image in such a way as to correspond to the relative position that is set based on the position of the marker 60 as a reference. The control unit 10 decides the display size of the image to have the prescribed value. When the image does not fit within the projection area PA, the control unit 10 changes one or both of the display position and the display size of the image so as to fit within the projection area PA.

In the display control step, the projector 1 decides the display position of the image in such a way as to correspond to the relative position that is set based on the position of the marker 60 as a reference. In the display control step, the projector 1 then decides the display size of the image to have the prescribed value. When the image does not fit within the projection area PA, the projector 1 changes one or both of the display position and the display size of the image according to the projection area PA.

Thus, the display position and the size of the image are decided, based on the arrangement of the marker 60, and the display position or size is adjusted so that the image fits within the projection area PA. Therefore, the user need not adjust the position of the marker 60, being aware of whether the projection image fits within the projection area PA or not. This can further improve the convenience of the projector 1.

When the image does not fit within the projection area PA, the control unit 10 reduces the display size of the image according to the projection area PA, while maintaining the aspect ratio. In the display control step, when the image does not fit within the projection area PA, the projector 1 reduces the display size of the image according to the projection area PA, while maintaining the aspect ratio.

Thus, the aspect ratio of the projection image is maintained, when the display position or size is adjusted so that the projection image fits within the projection area PA. Therefore, a deformation of the image that is not intended by the user can be prevented and the image intended by the user can be projected by a simple operation.

When the image does not fit within the projection area PA, the control unit 10 changes the relative position between the position of the marker 60 and the display position of the image in such a way as to correspond to the projection area PA. In the display control step, when the image does not fit within the projection area PA, the projector 1 changes the relative position between the position of the marker 60 and the display position of the image according to the projection area PA.

Thus, the projection image can be arranged at an appropriate position in the projection area PA, corresponding to the position of the marker 60.

The control unit 10 decides the display position of the image to become a position such that the position of the marker 60 is above the top-end side of the image or below the bottom-end side of the image. In the display control step, the projector 1 decides the display position of the image to become a position such that the position of the marker 60 is at the top-end side of the image or at the bottom-end side of the image.

Thus, by a simple operation, the projection image can be arranged at the position intended by the user. Also, since it is easy to understand the relationship between the marker 60 and the position of the projection image, higher operability can be achieved.

The control unit 10 decides the display position of the image, based on the positions of a plurality of the markers 60 having a common feature, of the detected markers 60. In the display control step, the projector 1 decides the display position of the image, based on the positions of a plurality of the markers 60 having a common feature, of the markers 60 detected in the detection step.

Since a combination of a plurality of the markers 60 having a common feature is thus arranged, a desired image can be displayed at a desired display position.

The control unit 10 decides the display position of the image, based on the positions of a plurality of the markers 60 having a common feature and detected at a position satisfying a particular condition. In the display control step, the projector 1 decides the display position of the image, based on the positions of a plurality of the markers 60 having a common feature and detected at a position satisfying a particular condition.

Since a plurality of markers 60 are thus arranged in such a way as to form a positional relationship that satisfies the position condition of the condition data 19, a desired image can be displayed at a desired display position. Also, since the projection image is not projected to the marker 60 that does not satisfy the position condition, an undesired image can be prevented from being projected.

The control unit 10 decides the display size of the image, based on the distance between a plurality of the markers 60. In the display control step, the projector 1 decides the display size of the image, based on the distance between a plurality of the markers 60.

Thus, the user can project the projection image in a desired size by arranging the markers 60.

The control unit 10 optically detects the marker 60 on the screen SC as a detection range. In the detection step, the projector 1 optically detects the marker 60 on the screen SC as a detection range.

Thus, optically detectable markers 60 of various kinds can be used in the projection system 100.

The image pickup unit 30 picking up an image of the screen SC is provided. The control unit 10 detects the position and the feature of the marker 60, based on the picked-up image data D by the image pickup unit 30. In the detection step, the projector 1 detects the position and the feature of the marker 60, based on the picked-up image of the screen SC.

Thus, optically detectable markers 60 of various kinds can be used in the projection system 100, and the markers 60 can be easily detected. When the projector 1 detects the marker 60 from the picked-up image data D based on visible light, it is advantageous in that the user can visually identify the feature of the marker 60.

For example, the feature of the marker is the apparent color or shape of the marker.

The control unit 10 detects a subject having a shape corresponding to a condition, as the marker 60, from the picked-up image data D. In the detection step, the projector 1 detects a subject having a shape corresponding to a condition, as the marker 60, from the picked-up image of the screen SC.

Since the feature of the marker 60 is the shape, the user can easily identify the feature of the marker 60.

The control unit 10 attempts to detect the marker 60 after starting the display of the image, and stops the display of the image when the marker 60 is not detected within a set time. The projector 1 attempts to detect the marker 60 in the detection step after starting the display of the image in the display step, and stops the display of the image when the marker 60 is not detected within a set time.

Thus, the image projected based on the position of the marker 60 can be erased from the projection area PA by a simple operation of eliminating the marker 60.

The control unit 10 may start the display of the image before detecting the marker 60. The projector 1 may start the display of the image in the display step before detecting the marker 60 in the detection step. For example, after the startup of the projector 1, in the non-detecting state ST1, the projection image may be projected in a set size at a preset position in the projection area PA before step S1 in FIG. 7 is executed. In this case, the projected image may be selected in advance from the image data 17 stored in the storage unit 15.

### 6. Other Embodiments

The embodiment is a specific example of the disclosure. The disclosure is not limited to this embodiment.

In the embodiment, the image projected by the projector 1 based on the position of the marker 60 is an image based on the image data 17. However, the disclosure is not limited to this. For example, the control unit 10 may be configured to select an image source corresponding to the feature of the marker 60 and project an image based on data of the selected image source. In this case, for example, the control unit 10 may select an image source corresponding to the feature of the marker 60, from the storage unit 15 and the interface 41, and display an image at a projection position based on the position of the marker 60.

In the embodiment, an example where the projector 1 optically detects the marker 60 is described. However, the disclosure is not limited to this. For example, the projector 1 may be configured to detect the marker 60 in the target range DA by wireless communication. For example, the marker 60 may be formed of a Bluetooth (trademark registered) beacon or RFID tag, and the projector 1 may receive a wireless signal from the marker 60 and thus detect the marker 60.

In the embodiment, a configuration where the target range DA coincides with the projection area PA is described as an example. However, the disclosure is not limited to this. The target range DA may preferably include a part of the projection area PA but need not coincide with the projection area PA. The target range DA may include the projection area PA and its peripheries. Alternatively, a part of the projection area PA may form the target range DA.

The display device according to the disclosure is not limited to the projector 1. For example, a liquid crystal monitor or liquid crystal television that displays an image on a liquid crystal panel may be used as a display device. Also, an OLED (organic light-emitting diode), OEL (organic electro-luminescence) display or the like may be used. The display device is also applicable to a device utilizing other display methods.

Each functional unit shown in FIG. 4 shows a functional configuration and is not limited to any specific form of embodiment. That is, hardware corresponding individually to each functional unit need not be installed. The functions of a plurality of functional units can be implemented by one processor executing a program. Also, the functions of one or a plurality of functional units can be implemented by a plurality of processors collaborating with each other. Moreover, a part of the functions implemented by software in the embodiment may be implemented by hardware, or a part o the functions implemented by hardware may be implemented by software. Also, the specific and detailed configurations of the other parts forming the projection system 100 can be arbitrarily changed without departing from the spirit and scope of the disclosure.

What is claimed is:

1. A method for controlling a display device, the method comprising:
a detection step of detecting a position and a feature of a marker arranged at a display surface;
a display control step of specifying an image that corresponds to the feature of the marker and deciding a display position of the image, based on the position of the marker; and
a display step of displaying the image at the display position.

2. A display device comprising:
a display unit; and
a control unit detecting a position and a feature of a marker arranged at a display surface, specifying an image that corresponds to the feature of the marker, deciding a display position of the image, based on the position of the marker, and causing the image to be displayed at the display position.

3. The display device according to claim 2, wherein
the control unit decides a display size of the image, based on the position of the marker.

4. The display device according to claim 3, wherein
a relative position between the position of the marker and the display position of the image and a prescribed value of the display size of the image are set in advance,
the control unit decides the display position of the image in such a way as to correspond to the relative position set based on the position of the marker, decides the display size of the image to have the prescribed value, and changes one or both of the display position and the display size of the image so as to fit within an available display area on the display surface, when the image does not fit within the available display area.

5. The display device according to claim 4, wherein
the control unit reduces the display size of the image to the available display area on the display surface in such a way as to maintain an aspect ratio, when the image does not fit within the available display area.

6. The display device according to claim 5, wherein
the control unit changes the relative position between the position of the marker and the display position of the image according to the available display area on the display surface, when the image does not fit within the available display area.

7. The display device according to claim 4, wherein
the control unit decides the display position of the image to become a position such that the position of the marker is above a top-end side of the image or below a bottom-end side of the image.

8. The display device according to claim 2, wherein
the control unit decides the display position of the image, based on positions of a plurality of the markers having a common feature, of the detected markers.

9. The display device according to claim 8, wherein
the control unit decides the display position of the image, based on positions of a plurality of the markers having a common feature and detected at a position satisfying a particular condition.

10. The display device according to claim 8, wherein
the control unit decides the display size of the image, based on a distance between a plurality of the markers.

11. The display device according to claim 2, wherein
the control unit optically detects the marker on the display surface as a detection range.

12. The display device according to claim 11, further comprising
an image pickup unit picking up an image of the display surface, wherein
the control unit detects the position and the feature of the marker, based on a picked-up image by the image pickup unit.

13. The display device according to claim 12, wherein
the control unit detects a subject having a shape corresponding to a condition, as the marker, from the picked-up image.

14. The display device according to claim 2, wherein
the control unit attempts to detect the marker after starting a display of the image, and stops the display of the image when the marker is not detected within a set time.

15. The display device according to claim 14, wherein
the control unit starts the display of the image before detecting the marker.

16. A method for controlling the display device according to claim 2, wherein
the feature of the marker is an apparent color or shape of the marker.

17. A display system comprising:
a display device; and
a marker arranged at a display surface, wherein
the display device comprises:
a display unit; and
a control unit detecting a position and a feature of the marker arranged at the display surface, specifying an image that corresponds to the feature of the marker, deciding a display position of the image, based on the position of the marker, and causing the image to be displayed at the display position.
